(19) United States
(12) Patent Application Publication
(10) Pub. No.: US 2023/0114706 A1
(43) Pub. Date: Apr. 13, 2023

(54) PLASTIC OPTICAL FIBER MANUFACTURING METHOD

(71) Applicant: NITTO DENKO CORPORATION, Ibaraki-shi, Osaka (JP)

(72) Inventors: Hiroshi Ohmura, Ibaraki-shi (JP); Yasuaki Okada, Ibaraki-shi (JP); Takeshi Saitou, Ibaraki-shi (JP)

(73) Assignee: NITTO DENKO CORPORATION, Ibaraki-shi, Osaka (JP)

(21) Appl. No.: 17/915,685

(22) PCT Filed: Mar. 25, 2021
(86) PCT No.: PCT/JP2021/012454

§ 371 Date: Sep. 29, 2022

(30) Foreign Application Priority Data
Mar. 31, 2020 (JP) 2020-063774

(51) Int. Cl. B29D 11/00; B29C 71/02

(52) U.S. Cl. CPC B29D 11/00663; B29C 71/02

(57) ABSTRACT

According to an embodiment of the present invention, there is provided a method of producing a plastic optical fiber having a small transmission loss. The method includes subjecting the plastic optical fiber to heat treatment. The plastic optical fiber includes a core portion and a cladding portion, the core portion is formed of a perfluorinated resin and having a refractive index gradient in a radial direction thereof.

### TECHNICAL FIELD

The present invention relates to a method of producing a plastic optical fiber.

### BACKGROUND ART

As an optical transmitter, a plastic optical fiber (hereinafter sometimes referred to as “POF”) whose core and cladding are each formed of a plastic is drawing attention. As the POF, there are typically known a step index type (SI type) and a graded index type (GI type). The SI-type POF has a problem of being unsuited for high-speed communication. The GI-type POF achieves a refractive index gradient through introduction of a refractive index adjuster (dopant) into its core portion. The GI-type POF is suited for high-speed communication but has a large transmission loss in some cases.

### CITATION LIST

### Patent Literature

[PTL 1] JP 4787731 B2

### SUMMARY OF INVENTION

### Technical Problem

The present invention has been made in order to solve the conventional problem as described above, and a primary object of the present invention is to provide a method of producing a plastic optical fiber having a small transmission loss.

### Solution to Problem

According to an embodiment of the present invention, there is provided a method of producing a plastic optical fiber. The method includes subjecting the plastic optical fiber to heat treatment. The plastic optical fiber includes a core portion and a cladding portion, the core portion is formed of a perfluorinated resin and having a refractive index gradient in a radial direction thereof.

In one embodiment, the core portion contains a dopant.

In one embodiment, the heat treatment is performed at a temperature lower than a glass transition temperature Tg of the perfluorinated resin.

In one embodiment, the heat treatment is performed at a temperature equal to or lower than a glass transition temperature Tg−30° C. of the perfluorinated resin.

In one embodiment, the heat treatment is performed for 12 hours or more.

In one embodiment, the heat treatment is performed after winding of the plastic optical fiber.

### Advantageous Effects of Invention

According to the present invention, in the method of producing a plastic optical fiber including the core portion, which is formed of the perfluorinated resin and has a refractive index gradient, the plastic optical fiber is subjected to heat treatment, and thus a plastic optical fiber having a small transmission loss can be simply produced.

### BRIEF DESCRIPTION OF DRAWINGS

FIG. 1 is a schematic sectional view for illustrating a cross section of an example of a plastic optical fiber that may be used in a production method according to an embodiment of the present invention, the cross section being orthogonal to the lengthwise direction of the plastic optical fiber.

### DESCRIPTION OF EMBODIMENTS

Embodiments of the present invention are described below. However, the present invention is not limited to these embodiments.

A. Method of Producing Plastic Optical Fiber

A method of producing a plastic optical fiber (POF) according to an embodiment of the present invention includes subjecting the POF to heat treatment. The POF to be used in the production method includes a core portion and a cladding portion, and the core portion is formed of a perfluorinated resin and has a refractive index gradient in the radial direction thereof. That is, the POF is of a GI type. It is known that, in a method of producing a POF, heat treatment is performed in order to relieve its residual stress and improve its shrinkage characteristic. Meanwhile, the inventors of the present invention have found that, when a GI-type POF whose core portion is formed of a specific perfluorinated resin is subjected to heat treatment, its transmission loss can be remarkably suppressed, and depending on the conditions of the heat treatment, its transmission characteristic can be improved. As a result, a POF that is applicable to high-speed communication and has a small transmission loss has been achieved. This is a finding obtained only after trial and error in improving the characteristics of the GI-type POF whose core portion is formed of the specific perfluorinated resin, is a result peculiar to such GI-type POF, and is an unexpected excellent result. A detailed configuration of the POF is described later in the section B.

A-1. Overview of Production Method

The POF to be subjected to the heat treatment may be produced by, for example, forming a preform in advance and stretching the preform. As used herein, the term “preform” refers to an unstretched POF including a core portion, a cladding portion, and an over-cladding portion. The preform may be obtained by any appropriate method. Typical examples of the method of producing the preform include a melt extrusion method, a melt spinning method, a melt extrusion dopant diffusion method, and a rod-in-tube method. In each of those methods, a procedure well known in the art may be adopted. For example, according to the melt extrusion method, the preform may be produced as follows: a material for forming the core portion, a material for forming the cladding portion, and a material for forming the over-cladding portion are each supplied to a concentric three-layer mold, and are melt-extruded at a predetermined temperature. In addition, for example, according to another melt extrusion method, the preform may be produced as follows: a material for forming the core portion and a material for forming the cladding portion are each supplied to a concentric two-layer mold, and are melt-extruded at a predetermined temperature, and further, through use of another two-layer mold, a material for forming the over-cladding portion, which is separately melt-extruded to the outside of a flow path of a melt of the core portion and the cladding portion, is joined thereto. In the melt spinning method, it is appropriate that a spinning nozzle (typically a three-layer nozzle) be used in place of the mold.

Next, the preform is stretched. The stretching temperature of the preform may be appropriately set in accordance with the materials for forming the core portion, the cladding portion, and the over-cladding portion. The stretching temperature is, for example, from 150° C. to 310° C., preferably from 200° C. to 260° C. A stretching ratio is typically 400 times or less, preferably from 5 times to 400 times, more preferably from 10 times to 400 times, still more preferably from 10 times to 350 times. A stretching speed is preferably from 1 m/min to 120 m/min, more preferably from 5 m/min to 90 m/min, still more preferably from 10 m/min to 75 m/min.

Thus, the POF may be produced. The series of operations from the preform formation to the stretching may be continuously performed, or a temporarily stored preform may be subjected to the stretching. The resultant POF is subjected to the heat treatment.

A-2. Heat Treatment

When the glass transition temperature of the perfluorinated resin is represented by Tg, the heat treatment is performed at: a temperature lower than Tg in one embodiment; a temperature equal to or lower than Tg−20° C. in another embodiment; a temperature equal to or lower than Tg−30° C. in still another embodiment; a temperature equal to or lower than Tg−35° C. in still another embodiment; or a temperature equal to or lower than Tg−40° C. in still another embodiment. Meanwhile, the heat treatment is performed at a temperature equal to or higher than Tg−70° C. in one embodiment; a temperature equal to or higher than Tg−60° C. in another embodiment; a temperature equal to or higher than Tg−55° C. in still another embodiment; a temperature equal to or higher than Tg−50° C. in still another embodiment; or a temperature equal to or higher than Tg−45° C. in still another embodiment. When the temperature of the heat treatment falls within such ranges, the transmission loss can be remarkably suppressed. The heat treatment temperature may be changed in accordance with a heat treatment time.

The heat treatment time may be changed in accordance with the heat treatment temperature. The heat treatment time is preferably 12 hours or more, more preferably 24 hours or more, still more preferably 30 hours or more, particularly preferably 36 hours or more. When the heat treatment time is equal to or longer than a predetermined period of time, the transmission loss can be remarkably suppressed. When the heat treatment time is excessively short, not only the effect of the embodiment of the present invention is not obtained, but rather, the transmission loss may be increased. The upper limit of the heat treatment time may be set from the viewpoints of production efficiency and cost, and may be, for example, 300 hours.

The combination of the heat treatment temperature and the heat treatment time is, for example, from Tg−55° C. to Tg-30° C. and 12 hours or more, from Tg−55° C. to Tg−30° C. and 36 hours or more, from Tg−50° C. to Tg−30° C. and 12 hours or more, from Tg-50° C. to Tg−30° C. and 36 hours or more, from Tg−45° C. to Tg−35° C. and 12 hours or more, from Tg−45° C. to Tg−35° C. and 36 hours or more, or from Tg−45° C. to Tg−35° C. and 48 hours or more.

The heat treatment may be performed under a state in which no tension is applied to the POF, or may be performed under a state in which a tension is applied thereto. When a tension is applied, the tension is preferably from 1 N/cm² to 20 N/cm², more preferably from 1 N/cm² to 10 N/cm², still more preferably from 2 N/cm² to 6 N/cm².

In one embodiment, the heat treatment is performed after winding of the POF. The heat treatment may be preferably performed within 8 hours after the completion of the winding.

B. Plastic Optical Fiber

### B-1. Overview of Plastic Optical Fiber

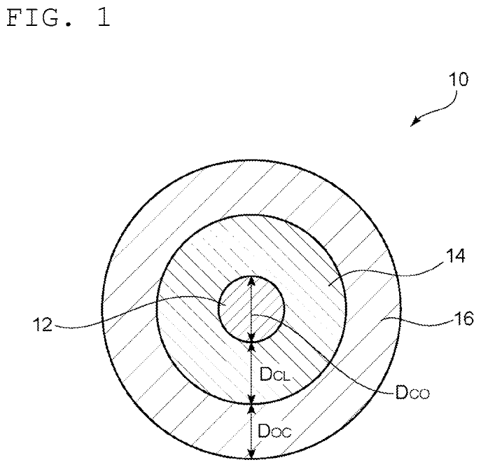

FIG. 1 is a schematic sectional view for illustrating a cross section of the POF that may be used in the above-mentioned production method, the cross section being orthogonal to the lengthwise direction of the POF. A POF 10 of the illustrated example includes a core portion 12, a cladding portion 14 arranged on the outer periphery of the core portion 12, and an over-cladding portion 16 arranged on the outer periphery of the cladding portion 14. Typically, the cladding portion 14 covers the entirety of the outer periphery of the core portion 12, and the over-cladding portion 16 covers the entirety of the outer periphery of the cladding portion 14. In the embodiment of the present invention, the POF is of a GI type. The POF may be of a multimode, or may be of a single mode.

B-2. Core Portion

As described above, the core portion 12 is formed of a perfluorinated resin. As used herein, the “perfluorinated resin” refers to a fluororesin substantially free of a CH bond. As described in the foregoing section A, when the POF whose core portion is formed of the perfluorinated resin is subjected to heat treatment, its transmission loss can be remarkably suppressed, and depending on the conditions of the heat treatment, its transmission characteristic can be improved. As also described in the foregoing section A, this is an effect peculiar to the POF whose core portion is formed of the perfluorinated resin.

Any appropriate perfluorinated resin may be used as the perfluorinated resin. Specific examples thereof include polytetrafluoroethylene, polyperfluoro-2-methylene-4-methyl-1,3-dioxolane, a polyperfluoroalkoxyalkane, polychlorotrifluoroethylene, polyperfluoroethylenepropane, and copolymers thereof. In one embodiment, the perfluorinated resin is a homopolymer obtained by polymerizing a monomer having a perfluoro(1,3-dioxolane) structure represented by the following formula (I).

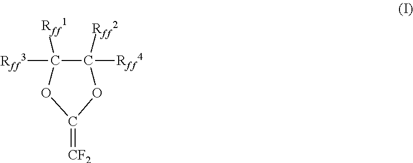

In the formula (I), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² may be linked to form a ring.

In another embodiment, the perfluorinated resin is a copolymer containing: a constituent unit (A) represented by the below-indicated formula (1); and at least one selected from the group consisting of a constituent unit (B) represented by the below-indicated formula (2), a constituent unit (C) represented by the below-indicated formula (3), and a constituent unit (D) represented by the below-indicated formula (4).

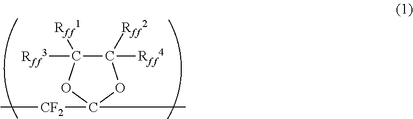

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² may be linked to form a ring.

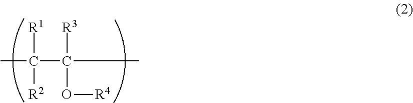

In the formula (2), R¹ to R³ each independently represent a fluorine atom, or a perfluoroalkyl group having 1 to 7 carbon atoms. R⁴ represents a perfluoroalkyl group having 1 to 7 carbon atoms. The perfluoroalkyl groups may each have a ring structure. Part of the fluorine atoms may be substituted with a halogen atom other than a fluorine atom. Part of the fluorine atoms in each of the perfluoroalkyl groups may be substituted with a halogen atom other than a fluorine atom.

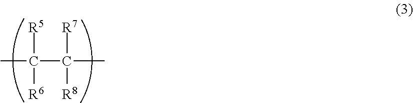

In the formula (3), R⁵ to R⁸ each independently represent a fluorine atom, or a perfluoroalkyl group having 1 to 7 carbon atoms. The perfluoroalkyl groups may each have a ring structure. Part of the fluorine atoms may be substituted with a halogen atom other than a fluorine atom. Part of the fluorine atoms in each of the perfluoroalkyl groups may be substituted with a halogen atom other than a fluorine atom.

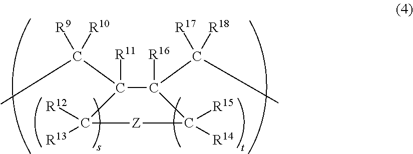

In the formula (4), Z represents an oxygen atom, a single bond, or —OC(R¹⁹R²⁰)O—, and R⁹ to R²⁰ each independently represent a fluorine atom, a perfluoroalkyl group having 1 to 5 carbon atoms, or a perfluoroalkoxy group having 1 to 5 carbon atoms. Part of the fluorine atoms may be substituted with a halogen atom other than a fluorine atom. Part of the fluorine atoms in the perfluoroalkyl group may be substituted with a halogen atom other than a fluorine atom. Part of the fluorine atoms in the perfluoroalkoxy group may be substituted with a halogen atom other than a fluorine atom. “s” and “t” each independently represent such an integer of from 0 to 5 that s+t is from 1 to 6 (provided that, when Z represents —OC(R¹⁹R²⁰)O—, s+t may be 0).

In a POF including a core portion formed of such perfluorinated resin as described above, the effect of the embodiment of the present invention becomes remarkable.

The core portion 12 preferably contains a dopant. The incorporation of the dopant can impart a refractive index gradient to the core portion. That is, a GI-type POF can be obtained. When a refractive index gradient is imparted to the core portion, a communication speed can be improved. In order to impart a refractive index gradient, it may be useful to adjust the concentration distribution of the dopant in the core portion. The dopant is preferably a compound that has compatibility with the perfluorinated resin serving as the main constituent component of the core portion, and that differs in refractive index from the perfluorinated resin. The use of a compound having satisfactory compatibility can prevent the occurrence of turbidity in the core portion to suppress a scattering loss to the extent possible, to thereby increase a communication distance. Typical examples of the dopant include perfluorobiphenyl, perfluoronaphthalene, trifluorobenzene trichloride, perfluoro-m-terphenyl, perfluoro-2-phenylnaphthalene, perfluoro-p-terphenyl, perfluorotriphenylene, perfluoroanthracene, perfluorotriphenylbenzene, perfluorobenzenodibenzodistibinin, perfluorotetraphenyltin, perfluorotriphenylphosphine, perfluorotriphenyltriazine, tris(dichloropentafluoropropyl)triazine, bisdichloropentafluoropropyl-6-pentafluorotriazine, a chlorotrifluoroethylene oligomer, perfluorodiphenyl sulfide, fluorinated fullerene, bispentafluorophenyl sulfoxide, bispentafluorophenylsulfone, trispentafluorophenylphosphine oxide, trispentafluorophenylphosphine sulfide, perfluoro-4,4′-diphenoxybiphenyl, perfluorotris(p-trifluoromethylphenyl)benzene, perfluorotris(m-trifluoromethylphenyl)benzene, and perfluorotris(o-trifluoromethylphenyl)benzene. Those dopants may be used alone or in combination thereof. Of those, perfluorobiphenyl, perfluorotriphenylbenzene, a chlorotrifluoroethylene oligomer, and perfluorodiphenyl sulfide are preferred. Those dopants can each improve the communication speed while maintaining the transparency and heat resistance of the core portion.

The content of the dopant in the core portion may be appropriately set in accordance with, for example, the desired configuration of the POF, the forming material and desired refractive index of the core portion, and the forming material and desired refractive index of the cladding portion. The content of the dopant may be, for example, from 0.1 part by weight to 25 parts by weight, or for example, from 1 part by weight to 20 parts by weight, or for example, from 2 parts by weight to 15 parts by weight with respect to 100 parts by weight of the material for forming the core portion. When the content of the dopant is excessively large, a fluctuation in density due to the dopant occurs to worsen the transmission loss in some cases. The refractive index of the core portion only needs to have a difference from the refractive index of the cladding portion (N_{CO}−N_{CL} to be described later), and the content of the dopant is preferably set to the minimum content for generating the difference in refractive index from the cladding portion.

The refractive index N_{CO} of the core portion is, for example, from 1.30 to 1.60. When the refractive index of the core portion falls within such range, the difference from the refractive index of the cladding portion can be easily made appropriate.

The diameter D_{CO} of the core portion is preferably from 10 μm to 2,000 μm, more preferably from 30 μm to 1,000 μm. When the diameter of the core portion falls within such ranges, there is an advantage in that, when a light source and the POF are connected to each other, the degree of freedom in their positioning is large.

B-3. Cladding Portion

The cladding portion 14 may be formed of any appropriate material. The cladding portion is typically formed of a perfluorinated resin. The perfluorinated resin is as described above in the foregoing section B-2 for the core portion.

The refractive index N_{CL} of the cladding portion is typically smaller than the refractive index N_{CO} of the core portion. The difference between the refractive index N_{CL} of the cladding portion and the refractive index N_{CO} of the core portion (N_{CO}−N_{CL}) is preferably 0.002 or more, more preferably 0.005 or more. The upper limit of the difference may be, for example, 0.02. When the difference falls within such ranges, there is an advantage in that, when optical transmission is performed, light escaping from the core to the outside of the cladding can be reduced.

The thickness D_{CL} of the cladding portion 14 is preferably from 2 μm to 300 μm, more preferably from 5 μm to 250 μm. When the thickness of the cladding portion falls within such ranges, mode dispersion can be suppressed to be small, and hence higher-speed communication becomes possible. Further, the POF itself can be thinned, and hence there are also advantages from the viewpoints of bendability and weight reduction.

B-4. Over-Cladding Portion

The over-cladding portion 16 may be formed of any appropriate material. The over-cladding portion may be preferably formed of a material having excellent mechanical characteristics and excellent adhesiveness to the cladding portion. Specific examples of such material include a polycarbonate-based resin and a cycloolefin-based resin. When the over-cladding portion is formed of any such resin, a POF excellent in transparency, heat resistance, and flexibility can be achieved. The polycarbonate-based resin is preferably a modified polycarbonate-based resin composited with polyester. This is because its chemical resistance and fluidity are excellent.

The thickness Doc of the over-cladding portion 16 is preferably from 50 μm to 500 μm, more preferably from 70 μm to 300 μm. When the thickness of the over-cladding portion falls within such ranges, the core portion and the cladding portion can be satisfactorily protected, and besides, flexibility and softness required of the POF can be satisfied.

### EXAMPLES

Now, the present invention is specifically described by way of Examples. However, the present invention is not limited to these Examples.

### Production Example 1

### 1-1. Production of POF

A perfluorinated resin and a dopant were melted and mixed, and then slowly cooled to produce a core rod, and a perfluorinated resin was melted and then slowly cooled to produce a cladding rod. The core rod, the cladding rod, and a material for forming an over-cladding portion were each supplied to a concentric three-layer mold, and were melt-extruded at 240° C. and drawn down at a stretching speed of 50 m/min and a stretching ratio of 30 times to provide a POF.

1-2. Glass Transition Temperature

The glass transition temperature of the perfluorinated resin for forming the core portion of the POF was determined by differential scanning calorimetry (DSC). The glass transition temperature was 135° C. The DSC measurement was specifically performed as described below. About 5 mg of a measurement sample was collected from the perfluorinated resin, and the measurement sample was placed in a simple closed container made of aluminum and was subjected to measurement using a differential scanning calorimeter “Q-2000” manufactured by TA Instruments. Measurement conditions were as described below.

Temperature program: −80° C. to 200° C.

Measurement speed: 10° C./min

Ambient gas: N₂ (50 ml/min)

### Example 1

The POF obtained in Production Example 1 was cut to a length of 1 m. Light having a wavelength of 850 nm was allowed to enter the entrance end surface of the cut POF (hereinafter referred to simply as “POF”), and power P1 of the light outgoing from the outgoing end surface was measured. “FOLS-01” manufactured by Craft Center SAWAKI Inc. was used as an apparatus for emitting the light having a wavelength of 850 nm. The power of the outgoing light was measured using “8230” manufactured by ADC Corporation.

Then, the POF was placed on an aluminum vat arranged in an oven, and was subjected to heat treatment at 90° C. (Tg of the core portion−45° C.) for 12 hours, 36 hours, and 48 hours. For the POF after the heat treatment for each period of time, power P2 of outgoing light was measured in the same manner as before the heat treatment.

A transmission loss change A per m of the POF (dB/m) was determined from the measured power P1 and power P2 through use of the below-indicated equation (1). The results are shown in Table 1. As is apparent from the equation (1), a smaller A means a smaller transmission loss change, and a case in which A is negative means an improvement in transmission characteristic.

A=P1−P2 (1)

### Example 2

Transmission loss changes A per m of the POF were determined in the same manner as in Example 1 except that the heat treatment temperature was changed to 70° C. (Tg of the core portion−65° C.). The results are shown in Table 1.

### Example 3

Transmission loss changes A per m of the POF were determined in the same manner as in Example 1 except that the heat treatment temperature was changed to 100° C. (Tg of the core portion−35° C.). The results are shown in Table 1.

### Example 4

Transmission loss changes A per m of the POF were determined in the same manner as in Example 1 except that the heat treatment temperature was changed to 115° C. (Tg of the core portion−20° C.). The results are shown in Table 1.

### Example 5

Transmission loss changes A per m of the POF were determined in the same manner as in Example 1 except that the heat treatment temperature was changed to 80° C. (Tg of the core portion−55° C.). The results are shown in Table 1.

### Comparative Example 1

Transmission loss changes A per m of the POF were determined in the same manner as in Example 1 except that the heat treatment was not performed (that is, the POF was left to stand at room temperature for 12 hours, 36 hours, and 48 hours). The results are shown in Table 1.

TABLE 1

| | | Transmission loss change A (dB/m) | | |
|---|---|---|---|---|
| | Heat treatment | After 12 | After 36 | After 48 |
| | temperature (° C.) | hours | hours | hours |
| Example 1 | 90 (Tg-45) | −9.5 | −9.5 | −10.7 |
| Example 2 | 70 (Tg-65) | −0.3 | −0.8 | −2.0 |
| Example 3 | 100 (Tg-35) | −6.6 | −7.2 | −7.0 |
| Example 4 | 115 (Tg-20) | −5.0 | −5.1 | −5.2 |
| Example 5 | 80 (Tg-55) | −4.3 | −4.6 | −4.8 |
| Comparative | No heat treatment | +0.1 | +0.1 | +0.2 |
| Example 1 | | | | |

<Evaluation>

As is apparent from Table 1, it is found that the POFs of Examples of the present invention are each improved in transmission characteristic by virtue of the heat treatment.

### INDUSTRIAL APPLICABILITY

The plastic optical fiber obtained by the production method of the present invention is useful as a constituent element of an optical fiber cable intended for high-speed communication. Further, the plastic optical fiber can be applied as a photoconductive element such as an optical waveguide by being changed in shape.

### REFERENCE SIGNS LIST

10 plastic optical fiber (POF)
12 core portion
14 cladding portion
16 over-cladding portion

1. A method of producing a plastic optical fiber,
the method comprising subjecting the plastic optical fiber to heat treatment,
the plastic optical fiber including a core portion and a cladding portion,
the core portion being formed of a perfluorinated resin and having a refractive index gradient in a radial direction thereof.

2. The method of producing a plastic optical fiber according to claim 1, wherein the core portion contains a dopant.

3. The method of producing a plastic optical fiber according to claim 1, wherein the heat treatment is performed at a temperature lower than a glass transition temperature Tg of the perfluorinated resin.

4. The method of producing a plastic optical fiber according to claim 3, wherein the heat treatment is performed at a temperature equal to or lower than a glass transition temperature Tg−30° C. of the perfluorinated resin.

5. The method of producing a plastic optical fiber according to claim 1, wherein the heat treatment is performed for 12 hours or more.

6. The method of producing a plastic optical fiber according to claim 1, wherein the heat treatment is performed after winding of the plastic optical fiber.

7. The method of producing a plastic optical fiber according to claim 1, wherein the plastic optical fiber further includes an over-cladding portion, the cladding portion covers the entirety of the outer periphery of the core portion, and the over-cladding portion covers the entirety of the outer periphery of the cladding portion.

8. The method of producing a plastic optical fiber according to claim 2, wherein the cladding portion is formed of a perfluorinated resin.

9. The method of producing a plastic optical fiber according to claim 8, wherein the difference between the refractive index N_{CL} of the cladding portion and the refractive index N_{CO} of the core portion (N_{CO}−N_{CL}) is from 0.002 to 0.02.

10. The method of producing a plastic optical fiber according to claim 1, further comprising: forming a preform and stretching the preform to produce the plastic optical fiber.

11. A method of producing a plastic optical fiber,
the method comprising subjecting the plastic optical fiber to heat treatment,
the plastic optical fiber including a core portion and a cladding portion,
the core portion being formed of a perfluorinated resin, containing a dopant and having a refractive index gradient in a radial direction thereof,
wherein the heat treatment is performed at a temperature from Tg−65° C. to Tg−20° C. and for 12 hours or more, the Tg being a glass transition temperature of the perfluorinated resin.

12. The method of producing a plastic optical fiber according to claim 11, wherein the cladding portion is formed of a perfluorinated resin.

13. The method of producing a plastic optical fiber according to claim 12, wherein the difference between the refractive index N_{CL} of the cladding portion and the refractive index N_{CO} of the core portion (N_{CO}−N_{CL}) is from 0.002 to 0.02.

14. The method of producing a plastic optical fiber according to claim 13, wherein the plastic optical fiber further includes an over-cladding portion, the cladding portion covers the entirety of the outer periphery of the core portion, and the over-cladding portion covers the entirety of the outer periphery of the cladding portion.

15. The method of producing a plastic optical fiber according to claim 14, wherein the over-cladding portion is formed of a polycarbonate-based resin or a cycloolefin-based resin.

16. The method of producing a plastic optical fiber according to claim 11, wherein the heat treatment is performed after winding of the plastic optical fiber.

17. The method of producing a plastic optical fiber according to claim 11, wherein the heat treatment is performed under a state in which no tension is applied to the plastic optical fiber.

18. The method of producing a plastic optical fiber according to claim 11, wherein the heat treatment is performed under a state in which tension of 1 N/cm² to 20 N/cm² is applied to the plastic optical fiber.
